(19) United States
(12) Patent Application Publication
(10) Pub. No.: US 2012/0319852 A1
(43) Pub. Date: Dec. 20, 2012

(54) DEVICE FOR PROVIDING AN INDICATION OF WHEN THE VOLUME OF LIQUID IN A BAG REACHES A PREDETERMINED VALUE

(75) Inventors: Charlotte Ruth Platten, Yarm Cleveland (GB); Robert Tapper, Middlesbrough Cleveland (GB); Michael John Broadhurst, Ovingham (GB)

(73) Assignee: The New Castle Upon Tyne Hospitals NHS Foundation Trust, Tyne and Wear (GB)

(21) Appl. No.: 13/510,410

(22) PCT Filed: Nov. 19, 2010
(86) PCT No.: PCT/GB2010/051924

§ 371 Date: Aug. 24, 2012

(30) Foreign Application Priority Data
Nov. 20, 2009 (GB) 0920345.6

(51) Int. Cl. G08B 21/18

(52) U.S. Cl. 340/619; 340/618

(57) ABSTRACT

A device that attaches to a bag provides an indication when the volume of matter in the bag reaches a predetermined value. The device includes a detachment detector that provides a detachment signal when the device detaches from the bag. First and second arms may be pivotally connected to each other and biased in a direction towards each other adjacent first ends of the arms. The first and second arms in use engage opposing sides of the bag. At least one bag level indicator provides a bag level signal when the volume of matter in the bag reaches the predetermined value.

The present invention relates to a device for providing an indication of when the volume of matter such as a liquid or a solid in a bag, reaches a predetermined value. The present invention is particularly, but not exclusively, suitable for providing an indication of when the volume of a bag for the collection of urine has reached a predetermined value.

A urostomy is an artificial opening, otherwise known as a stoma, for the urinary system of a patient. A urostomy is typically made in the event that long term drainage of urine through the bladder and urethra is no longer possible, for example after surgery or in the case of an obstruction.

A urostomy pouching system, commonly referred to as a urine bag, is a medical prosthetic which provides a means for the collection of urine from the diverted urinary system of a patient. The urine bag may be connected to the urostomy by a suitable fluid communication means, and is secured to the patient at a convenient location, for example the leg, so that it can be concealed underneath clothing but also accessed when it is required.

Alternatively, the urine bag may be connected to a catheter inserted into the urinary system of a patient.

During the course of a day, a urine bag will require emptying by either the patient themselves, or by a clinician if the patient is resident in hospital. However, if the urine bag is allowed to become over full, then back pressure can build up, possibly leading to infections in the urinary system of the patient.

Normally, the patient is able to anticipate when the bag becomes full or near full and requires emptying, by way of feeling the bag against their leg. However, if the patient suffers from paralysis then it is not normally possible for the patient to anticipate this by noticing a heavier than normal urine bag against their leg for example and so in this case it becomes necessary for either the patient themselves or a clinician to regularly visually monitor the urine bag. In the case where the patient is in hospital, this can be time consuming for the clinician, especially when the patient is in a busy ward. In the case where the patient is in the community, such visual monitoring can be inconvenient and embarrassing for the patient.

Preferred embodiments of the present invention seek to overcome or at least alleviate the above described disadvantages associated with the prior art and provide an improved means for indicating when a urine bag requires emptying without the requirement for visual monitoring by the patient or a clinician.

According to the present invention there is provided a device for attachment to a bag, for providing an indication when the volume of matter in the bag reaches a predetermined value, said device comprising detachment detection means for providing a detachment signal when the device detaches from the bag.

The device may further comprise:—(i) first and second arms pivotally connected to each other and biased in a direction towards each other adjacent first ends of the arms, said first and second arms in use engaging opposing sides of the bag; and (ii) bag level indicator means for providing a bag level signal when the volume of matter in the bag reaches a predetermined value.

The detachment detection means may be located adjacent said first ends of said first and second arms.

The detachment detection means may comprise first and second electrically conductive elements disposed on the first and second arms respectively, wherein the first and second electrically conductive elements contact each other to generate said detachment signal.

However, it is to be appreciated that the detachment detection means is not limited to electrically conductive elements and may comprise any suitable means for detecting when the first ends of the first and second arms respectively, come together. For example, the detachment detection means may comprise either (i) first and second capacitive elements; (ii) first and second magnetic elements; or (iii) an infra red transmitter and an associated infra red receiver.

Optionally, the device may further comprise a signal processor for processing the detachment signal and/or the bag level signal to generate at least one of an audible alarm condition, a visual alarm condition, a vibration alarm condition or a wireless signal.

The bag level indicator means may comprise an infra red transmitter disposed at the first end of the first arm, and an infra red receiver disposed at the first end of the second arm.

The bag level indicator means may provide a bag level signal in the event that the infra red receiver receives infra red radiation from the infra red transmitter with an intensity below a predetermined value.

However, it is to be appreciated that the bag level indicator means may comprise any suitable means for detecting when the first ends of the first and second arms respectively, move in a direction towards each other. For example, the bag level indicator means may comprise either (i) first and second capacitive elements or (ii) first and second magnetic elements.

Alternatively, the bag level indicator means may comprise a third electrically conductive element disposed at a second end of the first arm and a fourth electrically conductive element disposed at a second end of the second arm, wherein the third and fourth electrically conductive elements contact each other in the event that the first ends of the first and second arms are urged to a predetermined distance away from each other.

The bag level indicator means may provide a bag level signal when the third and fourth electrically conductive elements contact each other.

However, it is to be appreciated that the bag level indicator means may comprise any suitable means for detecting when the second ends of the first and second arms respectively, move in a direction towards each other. For example, the bag level indicator means may comprise either (i) first and second capacitive elements; (ii) first and second magnetic elements; or (iii) an infra red transmitter and an associated infra red receiver.

In another embodiment, the device may further comprise first and second arms pivotally connected to each other between first and second ends, the first ends being biased in a direction towards each other, the first ends in use engaging a portion of the bag.

In this case, the detachment detection means may comprise a first electrically conductive element disposed at the first end of the first arm and a second electrically conductive element disposed at the first end of the second arm, wherein the first and second electrically conductive elements contact each other in the event that the device detaches from the bag to generate the detachment signal.

However, it is to be appreciated that the detachment detection means may comprise any suitable means for detecting when the first ends of the first and second arms respectively, come together. For example, the detachment detection means may comprise either (i) first and second capacitive elements; (ii) first and second magnetic elements; or (iii) an infra red transmitter and an associated infra red receiver.

Optionally, the device may further comprise a signal processor for processing the detachment signal to generate at least one of an audible alarm condition, a visual alarm condition, a vibration alarm condition or a wireless signal.

Preferred embodiments of the present invention will now be described, by way of example only and not in any limitative sense, with reference to the accompanying drawings in which:—

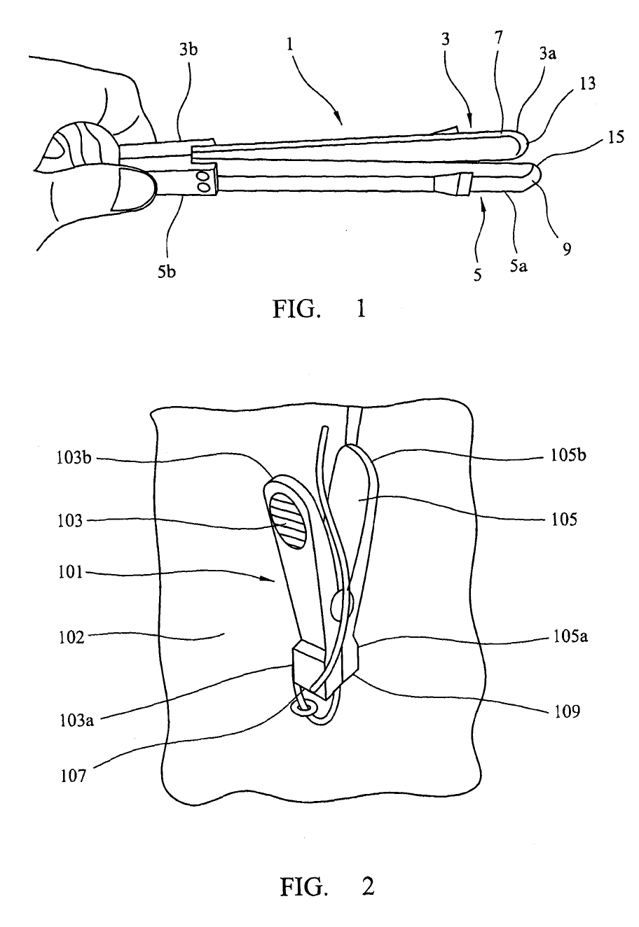

FIG. 1 shows a perspective view of a first embodiment of the device;

FIG. 2 shows a perspective view of a second embodiment of the device in situ on a urine bag; and

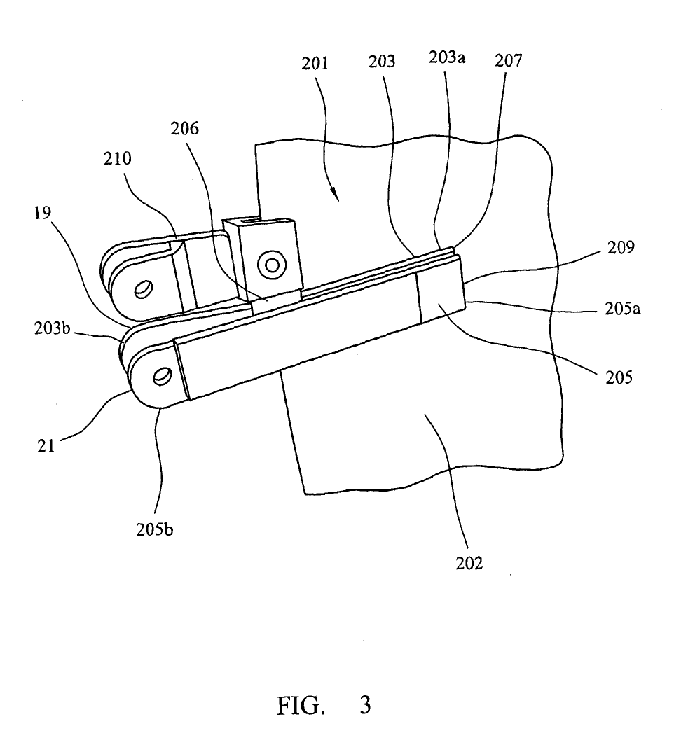

FIG. 3 shows a perspective view of a third embodiment of the device in situ on a urine bag.

With reference to FIG. 1, a first embodiment of a device for providing an indication of when the volume of liquid in a bag 2 reaches a predetermined value is represented generally by reference numeral 1.

The device 1 comprises a first arm 3 having a first end 3a and a second end 3b, and a second arm 5 having a first end 5a and a second end 5b. The first 3 and second 5 arms are pivotally connected to each other at their second ends 3b and 5b, and are spring loaded such as to urge the first ends 3a and 5a together in order to provide the necessary gripping action to retain the device 1 on the bag (not shown).

In the event that the user wishes to attach the device 1 to the bag (not shown), they simply squeeze the second ends 3b and 5b together, which causes the first ends 3a and 5a to move away from each other, thereby opening the first 3 and second 5 arms up. The first 3 and second 5 arms are then slotted over the bag (not shown) at which point the second ends 3b and 5b are released by the user in order to securely clip the device 1 to the bag (not shown). Additionally, the device 1 can be slotted through a hanging tab, which typically can be found on a bag for the purposes of hanging from a stand. This further prevents the device 1 from accidentally becoming detached from the bag.

The device 1 further comprises detachment detection means for providing a detachment signal if the device 1 accidentally becomes detached from the bag (not shown). The detachment detection means comprises a first electrically conductive element 7 disposed at the first end 3a of the first arm 3 and a second electrically conductive element 9 disposed at the first end 5a of the second arm 5. In the event that the device accidentally becomes detached from the bag (not shown), the first 7 and second 9 electrically conductive elements contact each other, at which point a detachment signal is generated.

Optionally, the device 1 further comprises a signal processor (not shown) which processes the detachment signal generated by the detachment detection means and provides either an audible alarm condition, a visual alarm condition, a vibration alarm condition or a wireless signal which can be transmitted to a remote monitoring device (not shown).

The device 1 further comprises a battery (not shown) disposed at a convenient location.

The device 1 further comprises a bag level indicator means comprising an infra red transmitter 13 disposed at the first end 3a of the first arm 3 adjacent the first electrically conductive element 7, and an infra red receiver 15 disposed at the first end 5a of the second arm 5 adjacent the second electrically conductive element 9. As the bag fills with urine, the intensity of the infra red radiation from the transmitter 13 impinging on the infra red receiver 15 decreases. This is on account of the increased distance between the transmitter 13 and the receiver 15 as the arms 3, 5 move away from each other. Further, the opacity of the bag increases as it fills with urine, thereby attenuating the infra red radiation from the infra red transmitter 13. In the event that the intensity of infra red radiation received by the infra red receiver 15 falls below a predetermined value, the infra red receiver 15 generates a bag level signal which is transmitted to the signal processor (not shown). The signal processor (not shown) then provides either an audible alarm condition, a visual alarm condition, a vibration alarm condition or a wireless signal to a remote monitoring device (not shown).

With reference to FIG. 2, a second embodiment of a device for providing an indication of when the volume of liquid in a bag 102 reaches a predetermined value is represented generally by reference numeral 101.

The device 101 comprises a first arm 103 having a first end 103a and a second end 103b, and a second arm 105 having a first end 105a and a second end 105b. The first 103 and second 105 arms are pivotally connected to each other at a point between the first 103a, 105a and second 103b, 105b ends but nearer the first ends 103a, 105a. The arms 103, 105 are arranged so that the first ends 103a, 105a are biased in a direction towards each other so that the first ends 103a, 105a in use grip a portion of the bag 102 formed by a small crease.

In the event that the user wishes to attach the device 101 to the bag 102, they simply squeeze the second ends 103b and 105b together, which urges the first ends 103a and 105a apart from each other, thereby opening the arms 103, 105 up. The device 101 is then clipped to a small crease made in the bag 102.

The device 101 further comprises a detachment detection means comprising a first electrically conductive element 107 disposed at the first end 103a of the first arm 103 and a second electrically conductive element 109 disposed at the first end 105a of the second arm 105, the first 107 and second 109 electrically conductive elements contacting each other in the event that the device 101 detaches from the bag 102, in order to generate a detachment signal.

The detachment signal may for example be a visual signal, a radio frequency signal for transmission to a remote monitoring device, an electrical signal transmitted along an electrically conductive element, an audible signal or a vibratory signal.

Optionally, the device 101 further comprises a signal processor (not shown) which processes the detachment signal generated by the detachment detection in the event that the first 107 and second 109 electrically conductive elements contact each other. In the event that the signal processor (not shown) receives a detachment signal, the signal processor provides either an audible alarm condition, a visual alarm condition, a vibration alarm condition or a wireless signal which is sent to a remote monitoring device (not shown).

The device 101 further comprises a battery (not shown) disposed at a convenient location.

In this way, in this embodiment, the detachment of the device 101 from the bag 102 serves as an indication of when the bag 102 becomes full or near full of urine. To elaborate, in the event that the bag 102 fills with urine, the crease in the bag 102 smoothes out, thereby forcing the device 101 to become detached from the bag 102.

With reference to FIG. 3, a third embodiment of a device for providing an indication of when the volume of liquid in a bag 202 reaches a predetermined value is represented generally by reference numeral 201.

The device 201 comprises a first arm 203 having a first end 203a and a second end 203b, and a second arm 205 having a first end 205a and a second end 205b. The first 203 and second 205 arms are pivotally connected to each other at pivot 206 disposed between the first 203a, 205a and second 203b, 205b ends respectively. The first ends 203a and 205a ends are biased in a direction towards each other and in this way, the first 203 and second 205 arms in use grip either side of the bag 202.

The device 201 further comprises a detachment detection means comprising a first electrically conductive element 207 disposed at the first end 203a of the first arm 203, and a second electrically conductive element 209 disposed at the first end 205a of the second arm 205, wherein the first 207 and second 209 electrically conductive elements contact each other in the event that the device 201 accidentally detaches from the bag 202, in order to generate a detachment signal.

It is to be appreciated however, that the first 207 and second 209 electrically conductive elements may be disposed at any suitable location along the first 203 and second 205 arms between the pivot 206 and the first ends 203a, 205a respectively.

Optionally, the device 201 further comprises a signal processor (not shown) which processes the detachment signal generated by the detachment detection in the event that the first 207 and second 209 electrically conductive elements contact each other. In the event that the signal processor (not shown) receives a detachment signal, the signal processor (not shown) provides either an audible alarm condition, a visual alarm condition, a vibration alarm condition or a wireless signal which is sent to a remote monitoring device (not shown).

The device 201 further comprises a battery (not shown) disposed at any convenient location.

The device 201 further comprises a bag level indicator means comprising a third electrically conductive element 219 disposed at the second end 203b of the first arm 203 and a fourth electrically conductive element 221 disposed at the second end 205b of the second arm 205. The third 219 and fourth 221 electrically conductive elements contact each other in the event that the first ends 203a, 205a of the first 203 and second 205 arms are urged in a direction away from each other, to generate a bag level signal. In this way, as the bag 202 fills with urine, the first ends 203a, 205a are urged further away from each other until the third 219 and fourth 221 electrically conductive elements eventually contact each other.

The signal processor (not shown) processes the bag level signal generated by the bag level indicator means in the event that the third 219 and fourth 221 electrically conductive elements contact each other. In the event that the signal processor (not shown) receives a bag level signal, the signal processor (not shown) provides either an audible alarm condition, a visual alarm condition, a vibration alarm condition or a wireless signal to a remote monitoring device (not shown).

The device 201 further comprises a securing clip 210 which helps to prevent the device 201 from accidentally becoming detached from the bag 202. The securing clip 210 acts independently of the arms 203, 205, and retains the device 201 on the bag 202 even in the event that the arms 203, 205 are opened by the presence of urine in the bag 202.

The devices 1, 101, 201 described above provide a convenient means for providing an alert in the event that a urine bag becomes full or near full. The positioning of the device 1, 101, 201 on the bag can be decided according to how full the bag has to be before the alert is provided.

It will be appreciated by persons skilled in the art that the above embodiments have been described by way of example only, and not in any limitative sense, and that various alterations and modifications are possible without departing from the scope of the invention as defined by the appended claims.

For example, it will be appreciated by persons skilled in the art that the invention could also be suitable for use as a device for attachment to a colostomy bag for providing an indication when the volume of faeces in the bag reaches a predetermined value.

By way of further example, in the first embodiment of the invention as described above, the infra red transmitter 13 and the infra red receiver 15 could additionally function as the detachment detection means as well as the bag level indicator means. In this case, when the infra red detector detects substantially 100% of the radiation transmitted from the infra red transmitter, then an alarm condition is provided, indicating that the device 1 has accidentally become detached from the bag.

It will also be appreciated by persons skilled in the art that even though bag level indication and detachment detection have been described herein with reference to electrical conduction and the received intensity of infra red light, bag level indication and detachment detection could alternatively be provided by either magnetic means or capacitive measurement.

It is also to be appreciated that although the embodiments described herein incorporate a signal processor, a simplified version of the device may function without this feature.

1. A device that attaches to a bag, and that provides an indication when a volume of matter in the bag reaches a predetermined value, said device comprising:
at least one detachment detector that provides a detachment signal when the device detaches from the bag.

2. A device as claimed in claim 1, further comprising:
first and second arms pivotally connected to each other and biased in a direction towards each other adjacent first ends of the arms, said first and second arms in use engaging opposing sides of the bag; and
at least one bag level indicator that provides a bag level signal when the volume of matter in the bag reaches the predetermined value.

3. A device as claimed in claim 2, wherein said detachment detector is located adjacent said first ends of said first and second arms.

4. A device as claimed in claim 2, wherein the detachment detector comprises first and second electrically conductive elements disposed on the first and second arms respectively, wherein the first and second electrically conductive elements contact each other to generate the detachment signal.

5. A device as claimed in claim 4, wherein the device further comprises a signal processor that processes the detachment signal and/or the bag level signal to generate at least one of an audible alarm condition, a visual alarm condition or a wireless signal.

6. A device as claimed in claim 2, wherein the at least one bag level indicator comprises an infra red transmitter disposed at the first end of the first arm, and an infra red receiver disposed at the first end of the second arm.

7. A device as claimed in claim 6, wherein the at least one bag level indicator provides a bag level signal in an event that the infra red receiver receives infra red radiation from the infra red transmitter with an intensity below a predetermined value.

8. A device as claimed in claim 2,
wherein the at least one bag level indicator comprises a third electrically conductive element disposed at a second end of the first arm and a fourth electrically conductive element disposed at a second end of the second arm, and
wherein the third and fourth electrically conductive elements contact each other in an event that the first ends of the first and second arms are urged to a predetermined distance away from each other.

9. A device as claimed in claim 8, wherein the at least one bag level indicator provides a bag level signal when the third and fourth electrically conductive elements contact each other.

10. A device as claimed in claim 1, further comprising first and second arms pivotally connected to each other between first and second ends, the first ends being biased in a direction towards each other, the first ends in use engaging a portion of the bag.

11. A device as claimed in claim 10, wherein the at least one detachment detector comprises a first electrically conductive element disposed at the first end of the first arm and a second electrically conductive element disposed at the first end of the second arm, wherein the first and second electrically conductive elements contact each other in an event that the device detaches from the bag to generate the detachment signal.

12. A device as claimed in claim 11, wherein the device further comprises a signal processor that processes the detachment signal to generate at least one of an audible alarm condition, a visual alarm condition or a wireless signal.

13. (canceled)

14. A device as claimed in claim 3, wherein the detachment detector comprises first and second electrically conductive elements disposed on the first and second arms respectively, wherein the first and second electrically conductive elements contact each other to generate the detachment signal.

15. A device as claimed in claim 3, wherein the at least one bag level indicator comprises an infra red transmitter disposed at the first end of the first arm, and an infra red receiver disposed at the first end of the second arm.

16. A device as claimed in claim 4, wherein the at least one bag level indicator comprises an infra red transmitter disposed at the first end of the first arm, and an infra red receiver disposed at the first end of the second arm.

17. A device as claimed in claim 5, wherein the at least one bag level indicator comprises an infra red transmitter disposed at the first end of the first arm, and an infra red receiver disposed at the first end of the second arm.

18. A device as claimed in claim 3,
wherein the at least one bag level indicator comprises a third electrically conductive element disposed at a second end of the first arm and a fourth electrically conductive element disposed at a second end of the second arm, and
wherein the third and fourth electrically conductive elements contact each other in an event that the first ends of the first and second arms are urged to a predetermined distance away from each other.

19. A device as claimed in claim 4,
wherein the at least one bag level indicator comprises a third electrically conductive element disposed at a second end of the first arm and a fourth electrically conductive element disposed at a second end of the second arm, and
wherein the third and fourth electrically conductive elements contact each other in an event that the first ends of the first and second arms are urged to a predetermined distance away from each other.

20. A device as claimed in claim 5,
wherein the at least one bag level indicator comprises a third electrically conductive element disposed at a second end of the first arm and a fourth electrically conductive element disposed at a second end of the second arm, and
wherein the third and fourth electrically conductive elements contact each other in an event that the first ends of the first and second arms are urged to a predetermined distance away from each other.
